(19) United States
(12) Patent Application Publication
(10) Pub. No.: US 2026/0044179 A1
(43) Pub. Date: Feb. 12, 2026

(54) CLOCK CONTROL METHOD FOR SLAVE DEVICE AND MICROPROCESSOR SYSTEM USING THE SAME

(71) Applicant: NUVOTON TECHNOLOGY CORPORATION, HSINCHU CITY (TW)

(72) Inventor: LING-I CHENG, Zhubei City (TW)

(21) Appl. No.: 19/270,948

(22) Filed: Jul. 16, 2025

(30) Foreign Application Priority Data
Aug. 6, 2024 (TW) 113129355

(51) Int. Cl. G06F 1/08; G06F 1/14

(52) U.S. Cl. CPC G06F 1/08; G06F 1/14

(57) ABSTRACT

A clock control method for a slave device and a microprocessor system using the same are disclosed. The clock control method for a slave device comprises connecting a microprocessor and a plurality of slave devices via a bus; controlling a clock signal to enable or disable for one of the plurality of slave devices through a corresponding one of a plurality of clock gating circuits; pre-decoding an instruction output by the microprocessor to the bus to obtain an address of the instruction; finding a specific slave device corresponding to the address from the plurality of slave devices; and when one of the plurality of clock gating circuits corresponding to the specific slave device is not enabled, enabling the one of the plurality of clock gating circuits so that the specific slave device operates normally to receive the instruction.

### CROSS-REFERENCE TO RELATED APPLICATION

This application claims the priority benefit of Taiwan application serial no. 113129355, filed Aug. 6, 2024, the full disclosure of which is incorporated herein by reference.

### BACKGROUND

### Technical Field

The present invention relates to microprocessor system technology, and particularly a clock control method for a slave device and a microprocessor system using the same.

### Description of Related Art

In the design of embedded systems, clock management is a critical issue. Most modern microcontroller units (MCU) include a plurality of subsystems, and each of the subsystems has a dedicated clock signal source. To save energy consumption, these clock signal sources are turned off when not in use. However, if these clock switches are not properly managed, it may lead to problematic system behavior.

Such a situation is common in some MCUs. Such an MCU usually includes a main central processing unit (CPU) kernel and one or more dedicated digital signal processing (DSP) subsystem(s). Each DSP subsystem has its own instruction memory (RAM) and data memory (RAM) which may be accessed by the main CPU directly. However, to access these memory units, it is required to activate a clock of the corresponding DSP subsystem first. Before accessing the instruction memory or the data memory, if the clock of the DSP subsystem has not been steadily activated yet, the main CPU may enter a hang status, ultimately resulting in a hard fault and causing a system crash.

### SUMMARY

An embodiment of the present invention provides a clock control method for a slave device and a microprocessor system using the same to avoid a hard fault causing system crash in a microprocessor system.

An embodiment of the present invention provides a microprocessor system, the microprocessor system including a bus, a microprocessor, a plurality of clock gating circuits and a clock gating control circuit. The microprocessor and each of a plurality of slave devices are electrically connected to the bus, in which each of the plurality of clock gating circuits is coupled to a corresponding one of the plurality of slave devices to determine whether each of the plurality of slave devices receives a corresponding clock signal. The clock gating control circuit is coupled to the microprocessor and the plurality of clock gating circuits to decode an instruction output from the microprocessor to the bus in advance, obtain an address of the instruction, and find the corresponding slave device of the address from the plurality of slave devices, in which when the corresponding clock gating circuit of the plurality of clock gating circuit does not conduct, the clock gating control circuit forces the corresponding clock gating circuit to conduct.

Another embodiment of the present invention provides a clock control method for a slave device, the method for clock control of a slave device including: connecting a microprocessor and a plurality of slave devices on a bus; controlling whether a clock signal is enabled through a plurality of corresponding clock gating circuits for the plurality of slave devices; pre-decoding an instruction output by the microprocessor to the bus to obtain an address of the instruction; finding a specific slave device corresponding to the address from the plurality of slave devices; and when a corresponding clock gating circuit of the specific slave device is not enabled, controlling the clock gating circuit so that the specific slave device operates normally to receive the instruction.

In conclusion, embodiments of the present invention provide a microprocessor system and a clock control method for a slave device. Through the design of using a clock control circuit and clock gating circuits, the system may selectively make a specific slave device receive a clock signal according to an instruction and an address output by the microprocessor so that the slave device may operate normally and execute the instruction. Such a design may effectively save energy because unnecessary slave devices do not receive the clock signal when not selected, thereby reducing unnecessary power consumption. Also, it simplifies the system control flow, in which the microprocessor merely needs to output the instruction and the address without additional control signals to control the activation of slave devices, increasing the flexibility and expandability of the system. Thus, embodiments of the present invention are beneficial in increasing power efficiency and simplicity of control of a microprocessor system.

To further understand the technology, means and effects of the present invention, the following detailed description and accompanied drawings may be referred to understand the targets, features and concepts of the present invention thoroughly and specifically. However, the following detailed description and drawings are merely provided as references and explanations of the embodiments of the present invention and not as limitations of the present invention.

### BRIEF DESCRIPTION OF THE DRAWINGS

The drawings are provided for persons skilled in the art of the present invention to further understand the present invention and are incorporated into and constitute part of the disclosure of the present invention. The drawings show exemplary embodiments of the present invention and are used to explain the principles of the present invention alongside the Specification of the present invention.

FIG. 1 illustrates a circuit block diagram of a microprocessor system of a preferred embodiment of the present invention.

FIG. 2 illustrates a circuit block diagram of a microprocessor system of another preferred embodiment of the present invention.

FIG. 3 illustrates a flowchart of a clock control method for a slave device of a preferred embodiment of the present invention.

### DETAILED DESCRIPTION

Herein, exemplary embodiments of the present invention are referred to in detail, and the exemplary embodiments are shown in the drawings. Same reference numerals are used to represent same or similar elements in the drawings and specification whenever possible. Also, the approach of an exemplary embodiment is merely one of the implementations of the design concepts of the present invention, and the following examples are not intended to limit the present invention.

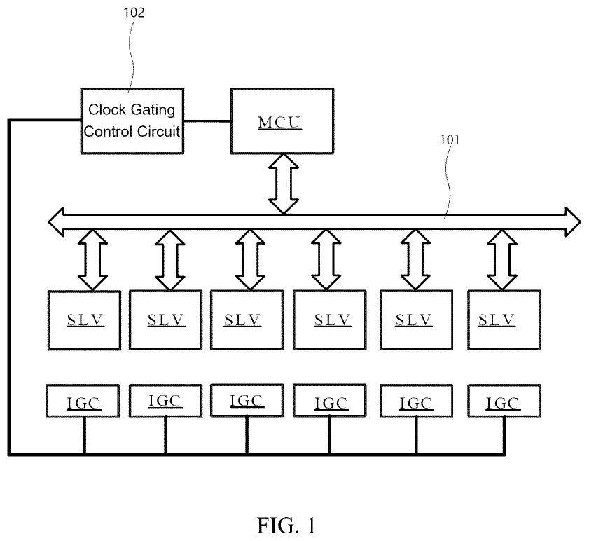

FIG. 1 illustrates a circuit block diagram of a microprocessor system of a preferred embodiment of the present invention. Referring to FIG. 1, the microprocessor system includes a microprocessor unit MCU, a bus 101, a plurality of slave devices SLV, a plurality of clock gating circuits IGC, and a clock gating control circuit 102. The microprocessor unit MCU and each of the slave devices SLV are electrically connected to the bus 101. Usually, in the microprocessor system, there are a plurality of external IP (Intellectual Property) modules, which are the slave devices SLV, and the operating clock frequency requirements of the IP modules may not be the same. Thus, clock signals connected to the clock gating circuits IGC corresponding to the slave devices SLV may differ according to the attributes of the slave devices SLV as well.

In the present embodiment, the microprocessor system adopts clock gating technology, which activates corresponding clock supply only when the slave device SLV really needs to operate. This allows each slave device SLV module to be individually configured with the most suitable clock frequency and activation time based on its operational requirements to avoid excessive overclocking causing resource waste. In the present embodiment, the clock gating control circuit 102 plays the role of turning on or off the clock gating circuits IGC at appropriate time.

For example, the clock gating control circuit 102 may execute an artificial intelligence (AI) model to dynamically output the corresponding weights for the slave devices SLV according to user operations; in an embodiment, the clock gating control circuit 102 may also adjust an operation speed of each slave device SLV. For instance, each SLV may use a clock with a corresponding clock frequency divider, and by controlling the clock divider, the frequency of the clock used by each SLV can be adjusted to speed up or slow down its operation. As such, a turning on time and a turning off time of the clock gating circuit corresponding to the slave device SLV are controlled. Thus, while training the AI model, a user situation is also adopted to adjust parameters of the AI model, and thereby dynamically adjusts the corresponding weights for the slave devices SLV to achieve the control of respective corresponding clock gating circuits. According to attributes of the product, the user situation may have, for example, standby mode, power-saving mode, memory mode, maximum performance mode, a temperature of the slave device, a utilization rate of the slave device, and so on. Among the operation modes, temperature, utilization rate and the like mentioned above, select at least one thereof to adjust (or train) the parameters of the AI model. Also, generally speaking, an adjusting target of the parameters of the AI model may be, for example, focused on minimum of a system response time and minimum of a system power consumption. In an embodiment, each user situation corresponds to a utilization time and a standby time of the current MCU under such a user situation. Such times may be provided to a user as a basis of adjustments. In an embodiment, the utilization time and the standby time may be adjusted by adjusting the on/off states and the frequency of the slave device SLV through the clock gating control circuit 102.

However, even though using an AI model, unexpected clock shutdown may still occur in the clock gating control circuit 102. That is, when the microprocessor unit MCU needs to access a certain slave device SLV, the clock gating circuit IGC corresponding to the slave device SLV is turned off, which causes the clock signal not being provided to the slave device SLV. Such a situation may cause the entire system to crash.

In the present embodiment, the clock gating control circuit 102 further includes a function of decoding instructions of the microprocessor unit MCU. When the microprocessor unit MCU sends an instruction to the bus 101, the clock gating control circuit 102 receives the instruction sent from the microprocessor unit MCU at the same time, pre-decodes the instruction output from the microprocessor unit MCU to the bus, and obtains an address corresponding to the instruction. At the moment, the clock gating control circuit 102 may immediately know which of the slave devices SLV has the clock signal to be turned on. When the clock signal of the slave device SLV has already been turned on, the clock gating control circuit 102 takes no action. When the clock signal of the slave device SLV is not turned on yet, the clock gating control circuit 102 immediately forces the clock gating circuit IGC corresponding to the slave device SLV to turn on for avoiding the entire system from unexpected crashing.

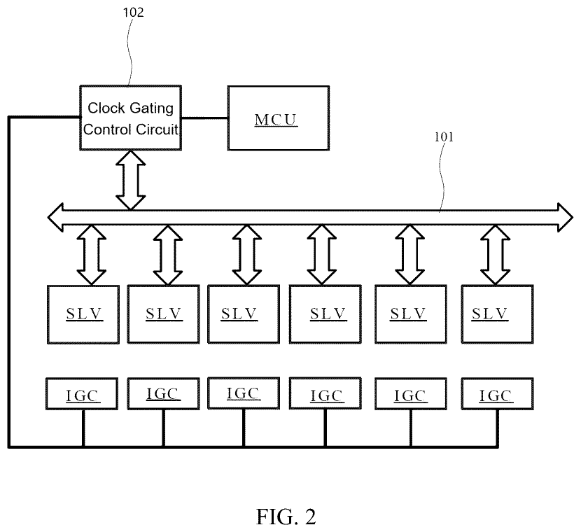

FIG. 2 illustrates a circuit block diagram of a microprocessor system of a preferred embodiment of the present invention. Referring to FIGS. 1 and 2, the difference between the microprocessor system circuit in FIG. 2 and the circuit in FIG. 1 is that the microprocessor unit MCU in FIG. 2 and the clock gating control circuit 102 are coupled in a different manner. In the present embodiment, the microprocessor unit MCU needs to send the instruction to the clock gating control circuit 102 first, and then the instruction is sent from the clock gating control circuit 102 to the bus 101. Both embodiments are applicable, and the present invention is not limited to the coupling relationships between the clock gating control circuit 102 and the microprocessor unit MCU disclosed above.

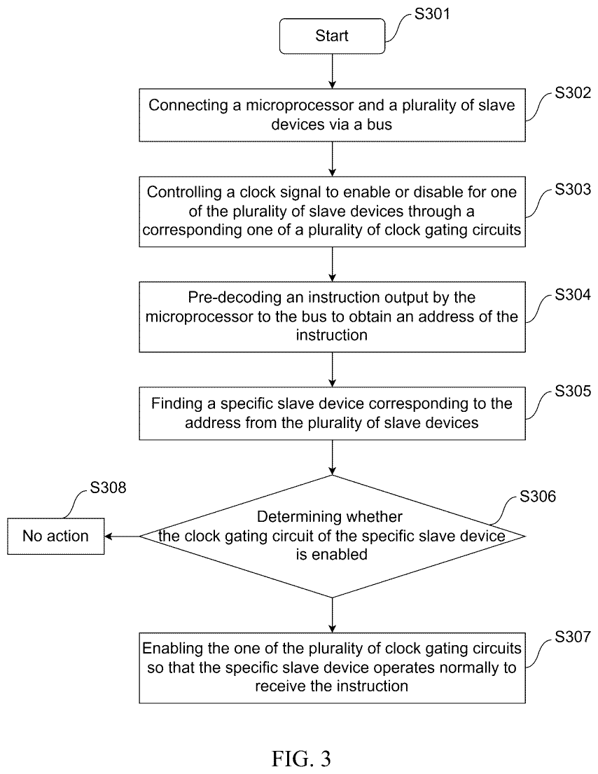

From the embodiments disclosed above, a clock control method for a slave device may be summarized. FIG. 3 illustrates a flowchart of a clock control method for a slave device of a preferred embodiment of the present invention. Referring to FIG. 3, the clock control method for a slave device includes the following steps:

Step S301: Start.

Step S302: Connect a microprocessor and a plurality of slave devices to a bus.

Step S303: The clock signals are controlled for the plurality of slave devices via the corresponding clock gating circuits. As in the aforementioned embodiments, each slave device (SLV) has a corresponding clock gating circuit (IGC).

Step S304: The instruction output from the microprocessor to the bus is pre-decoded to obtain the address corresponding to the instruction. In the aforementioned embodiment, the clock gating control circuit 102 pre-decodes the instruction output from the microprocessor unit MCU to the bus to obtain the address of the corresponding slave device SLV.

Step S305: A specific slave device corresponding to the address is identified from the plurality of slave devices.

Step S306: It is determined whether the clock gating circuit of the specific slave device is enabled. If the determination is negative, step S307 is performed. If the determination is positive, step S308 is performed.

Step S307: The corresponding clock gating circuit is controlled to enable the specific slave device to operate normally and receive the instruction.

Step S308: No action.

In conclusion, embodiments of the present invention provide a microprocessor system and a clock control method for a slave device. Through the design of using a clock gating control circuit and clock gating circuits, the system may selectively make a specific slave device receive the clock signal according to the instruction and address output by the microprocessor so that the specific slave device may operate normally and receive the instruction. Such a design may effectively save energy because unused slave devices do not receive the clock signal when not selected, thus reduces unnecessary power consumption. Also, the design simplifies the system control flow, in which the microprocessor merely needs to output the instruction and the address without additional control signals to control the activation of slave devices, which increases the flexibility and expandability of the system. Thus, embodiments of the present invention are beneficial in increasing power efficiency and control simplicity of a microprocessor system.

It should be understood that the examples and embodiments described herein are merely intended to be used as explanations, and various modifications or alterations in view of which are suggested to those skilled in the art and are included within the spirit and scope of the present application and the scope of the appended claims of the present disclosure.

What is claimed is:

1. A microprocessor system, comprising:
a bus;
a microprocessor electrically connected to the bus;
a plurality of slave devices, wherein each of the plurality of slave devices is electrically connected to the bus;
a plurality of clock gating circuits, wherein each of the plurality of clock gating circuits is coupled to a corresponding one of the plurality of slave devices to determine whether each of the plurality of slave devices receives a corresponding clock signal; and
a clock gating control circuit coupled to the microprocessor and the plurality of clock gating circuits, and configured to pre-decode an instruction output by the microprocessor to the bus, obtain an address of the instruction, and find a specific slave device corresponding to the address from the plurality of slave devices,
wherein, before the microprocessor executes the instruction, when the clock gating circuit corresponding to the specific slave device among the plurality of clock gating circuits is not enabled, the clock gating control circuit forces the clock gating circuit corresponding to the specific slave device to be enabled.

2. The microprocessor system according to claim 1, wherein the clock gating control circuit executes an artificial intelligence model to dynamically output corresponding weights of the plurality of slave devices according to a user situation of the microprocessor system to respectively control the plurality of clock gating circuits.

3. The microprocessor system according to claim 2, wherein the user situation is at least one of a standby mode, a power-saving mode, a memory mode, a maximum performance mode, temperatures of the plurality of slave devices, and utilization rates of the plurality of slave devices.

4. The microprocessor system according to claim 2, wherein an adjusting target of parameters of the artificial intelligence model comprises:
minimum of a system response time; and
minimum of a system power consumption.

5. A clock control method for a slave device, comprising:
connecting a microprocessor and a plurality of slave devices via a bus;
controlling a clock signal to enable or disable for one of the plurality of slave devices through a corresponding one of a plurality of clock gating circuits;
pre-decoding an instruction output by the microprocessor to the bus to obtain an address of the instruction;
finding a specific slave device corresponding to the address from the plurality of slave devices; and
when one of the plurality of clock gating circuits corresponding to the specific slave device is not enabled, enabling the one of the plurality of clock gating circuits so that the specific slave device operates normally to receive the instruction.

6. The clock control method according to claim 5, further comprising:
executing an artificial intelligence model to dynamically output a corresponding weight of the plurality of slave devices according to a user situation to respectively control the plurality of clock gating circuits.

7. The clock control method according to claim 6, wherein the user situation is at least one of a standby mode, a power-saving mode, a memory mode, a maximum performance mode, temperatures of the plurality of slave devices, and utilization rates of the plurality of slave devices.

8. The clock control method according to claim 6, wherein an adjusting target of parameters of the artificial intelligence model comprises:
minimum of a system response time; and
minimum of a system power consumption.
